(19) United States
(12) Patent Application Publication
(10) Pub. No.: US 2008/0191673 A1
(43) Pub. Date: Aug. 14, 2008

(54) Series regulator circuit

(75) Inventor: Hiroyuki KIMURA, Sendai (JP)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/015,516

(22) Filed: Jan. 17, 2008

(30) Foreign Application Priority Data
Feb. 8, 2007 (JP) 2007-29738

(51) Int. Cl. G05F 1/10

(52) U.S. Cl. 323/280

(57) ABSTRACT

A series regulator circuit that enables accurate detection of the rising of an output voltage even when the output voltage fluctuates. The series regulator circuit uses an operational amplifier including a first constant current source, first and second transistors for distributing the current of the first constant current source, and a third transistor connected to the second transistor The gate terminals of the first and second transistors are respectively supplied with a reference voltage and a negative feedback voltage. Output of the operational amplifier is amplified by an amplifier. A fourth transistor forms a current mirror circuit with the third transistor. A second constant current source forms a current comparator with the current that flows to the fourth transistor. A connection node of the fourth transistor and the second constant current circuit is connected to the input terminal of an inverter. The output from the inverter is used as a power-up detection signal. The current value of the second constant current source is less than a current value il of the constant current source and greater current value [i1]/2.

### BACKGROUND OF THE INVENTION

The present invention relates to a series regulator circuit that implements a power-up detection function for detecting the rising of an output voltage to a fixed value.

When activating an electronic circuit, unstable voltage may cause a defective circuit operation. To solve such a problem, Japanese Patent Publication No. 2000-31807 (FIG. 2) describes a power ON reset circuit used to output a reset signal that initializes the operation of each circuit when the voltage stabilizes. The power ON reset circuit includes a reference voltage generator for generating a reference voltage, a power supply voltage detector for generating activation voltage that is proportional to a power supply voltage, and a reset signal generator for comparing the reference voltage and the activation voltage to generate a reset signal. The power ON reset circuit further includes a delay circuit. The reset signal generator generates an output in a first logic state until the power supply voltage reaches a predetermined level and an output in a second logic state when the power supply voltage reaches the predetermined level. Based on a signal from the delay circuit, a reset signal generation circuit inactivates the reset circuit and maintains the output in the second logic state.

National Semiconductor “LMS33460 3V Under Voltage Detector”, [online], (searched on Jan. 26, 2006], Internet <URL: http://www.national.com/ds/LM/LMS33460.pdf.> describes a voltage drop detection circuit used as a circuit that switches signals in accordance with the level of a power supply voltage. The voltage drop detection circuit detects voltage drops caused by one reason or another (e.g., short-circuiting of power supply). This is effective for avoiding deficiencies, such as a voltage drop, caused by a sudden increase in the load current. The voltage drop detection circuit includes a comparator for comparing a detection voltage, which is used to detect voltage obtained by dividing an input voltage, and a reference voltage, which is output from a constant voltage source. The comparator has an output terminal connected to the gate terminal of an n-channel MOS transistor. The comparator provides the comparison result of the detection voltage and reference voltage to the MOS transistor. This varies the output voltage in accordance with the voltage at the gate terminal of the MOS transistor and thereby enables detection of a voltage drop.

A series regulator circuit and a voltage drop detection configuration that are known in the prior art may be combined to form a series regulator circuit implementing a voltage drop detection function. Such a series regulator circuit is shown in FIG. 8.

FIG. 8 shows a series regulator circuit 80, which includes an operational amplifier 81, an n-channel MOS. transistor 82, a comparator 83, and resistors 85, 86, and 87 respectively having resistances R1, R2, and R3. The operational amplifier 81 is supplied with a reference voltage Vref and an output voltage Vout. The operational amplifier 81 provides a comparison result of these voltages to the gate terminal of the MOS transistor 82. The MOS transistor 82 is connected to a power supply VCC line and a ground voltage GND line. The series regulator circuit 80 has an output terminal formed by a connection node of the MOS transistor 82 and the resistor 87. When the output voltage Vout becomes low, the series regulator circuit 80 varies the gate voltage of the MOS transistor 82 and increases the output voltage. When the output voltage Vout becomes high, the series regulator circuit 80 varies the gate voltage of the MOS transistor 82 and decreases the output voltage. This keeps the output voltage Vout substantially constant. The comparator 83 is supplied with the output voltage Vout and a divided voltage of the reference voltage Vref that is in accordance with the resistances R1 and R2. The comparator 83 outputs a detection signal S0 having a high level when the voltage is lower than a detection voltage V0.

The rising of the output voltage may be detected with the series regulator circuit 80, which implements a voltage drop detection function. For example, in the series regulator circuit 80 shown in FIG. 8, the detection signal S0 shifts from a high level to a low level when the output voltage Vout exceeds the detection voltage V0, as shown in FIG. 9A. Accordingly, the rising of the output voltage may be detected when the detection signal S0 is output at a low level by setting the detection voltage V0 to be slightly lower than the reference voltage.

However, depending on the load or offset of each circuit, the output voltage Vout may overshoot and then become constant at a voltage that is lower than the detection voltage V0, as shown in FIG. 9B. In such a case, the detection signal S0 temporarily shifts to a low level and then returns to a high level.

An offset may be caused, for example, by an operational amplifier in the series regulator circuit 80 or a detection circuit that outputs the detection signal S0. When the detection circuit includes an offset, as shown in FIG. 9C, the detection voltage V0 may be shifted to a higher level. Accordingly, even when the output voltage Vout reaches a fixed voltage (final voltage), the detection signal So does not shift to a low level.

In this manner, when the output voltage becomes constant at a value lower than the detection voltage V0, the detection signal S0 may be output at a high level even though the output voltage has risen. As a result, the rising of the output voltage cannot be accurately detected.

Further, as shown in FIG. 8, in the series regulator circuit 80 of the prior art, the circuit section that generates the output voltage Vout is formed separately from the circuit section that determines the detection voltage. V0. In such a circuit configuration, to determine whether the output voltage V0 has reached the final voltage, the accuracy of the output voltage Vout and the detection voltage V0 must be as high as possible and be within an error determination toleration range. However, if the accuracy required for the output voltage Vout is not that high, there would be no need for a circuit that increases the accuracy of the output voltage Vout when detecting whether the output voltage Vout has reached the final voltage.

Additionally, even when forming a circuit that accurately outputs the output voltage Vout and the detection voltage V0, a load or noise may vary the output voltage Vout. In such a case, even if the detection voltage V0 is accurately output, the rising of the output voltage cannot be accurately detected if the varying range is large.

### SUMMARY OF THE INVENTION

Accordingly, it is an object of the present invention to provide a series regulator circuit for accurately detecting the rising of an output voltage even when the output voltage fluctuates or includes an offset.

One aspect of the present invention is a series regulator including an operational amplifier incorporating a differential means formed by a first transistor and a second transistor, which distribute current of a first constant current source. The series regulator circuit outputs an output voltage in accordance with an output of the operational amplifier. The series regulator circuit includes a variable current source for outputting current having a current value that is proportional to current flowing to the first transistor or the second transistor. A second constant current source forms the variable current source and a current comparator. The first transistor has a control terminal supplied with a reference voltage. The second transistor has a control terminal supplied with a negative feedback voltage that is based on the output voltage. Current that is in accordance with the voltage difference between the negative feedback voltage and the reference voltage flows to the first transistor and second transistor. The second constant current source generates current having a predetermined current value, which is in the range of the current output from the variable current source, from when entering an activated state in which the reference voltage is supplied to when the negative feedback voltage and the reference voltage become equal to each other. Voltage at a connection node of the variable current source and the second constant current source is used to output a power-up detection signal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a circuit diagram of a series regulator circuit according to a first embodiment of the present invention;

FIG. 2 is an equivalent circuit diagram taken at an element level of the series regulator circuit show in FIG. 1;

FIG. 3 is a time chart of the series regulator circuit shown in FIG. 1;

FIG. 4A is a time chart showing the current in relation with the voltage in an operational amplifier;

FIG. 4B is a time chart showing the voltage output from a current comparator in relation with the current;

FIG. 5 is a circuit diagram of a series regulator circuit according to a second embodiment of the present invention;

FIG. 6 is a circuit diagram of a series regulator circuit according to a third embodiment of the present invention;

FIG. 7 is a circuit diagram of a series regulator circuit according to a fourth embodiment of the present invention;

FIG. 8 is a circuit diagram of a prior art series regulator circuit;

FIG. 9A is a diagram showing the relationship between an output voltage and detection signal in a prior art series regulator circuit when the output voltage is higher than the detection voltage;

FIG. 9B is a diagram showing the relationship between the output voltage and detection signal in the prior art series regulator circuit when the output voltage overshoots and then becomes lower than the detection voltage; and

FIG. 9C is a diagram showing the relationship between the output voltage and detection signal in the prior art series regulator circuit when the output voltage does not reach the detection voltage.

### DETAILED DESCRIPTION OF THE PREFERRED EMBODIMENTS

A first embodiment of the present invention will now be discussed with reference to FIGS. 1 to 4.

As shown in FIG. 1, a series regulator circuit 10 includes an operational amplifier A1, an amplifier A2, a constant current source 21, a transistor M9, and an inverter 22.

The operational amplifier A1 includes a constant current source 11, which functions as a first constant current source, and transistors M3, M5, and M6. The constant current source 11 is connected to a power supply voltage VCC line and outputs current having a current value i1. The transistors M3 and M5 are connected to the constant current source 11 and form a so-called differential pair (differential means) for dividing the current having current value i1 that is generated by the constant current source 11. In the first embodiment, the transistors M3 and M5 are p-channel transistors and each have a source terminal connected to the constant current source 11. Accordingly, the current that flows from the power supply voltage VCC line via the constant current source 11 to the transistors M3 and M5 is in accordance with the gate-source voltage difference.

Furthermore, the transistors M3 and M5 respectively have gate terminals (control terminals) that directly or indirectly receive signals input to an inversion input terminal and a non-inversion input terminal of the operational amplifier A1. More specifically, the circuit including the transistors M3 and M5 is a circuit or one of a plurality of circuits connected in a subordinate manner to a path extending from the input to the output of the operational amplifier A1. The circuit of the transistors M3 and M5 may be formed so that changes in the input of the operational amplifier A1 occur in a manner that the sign of the input of the operational amplifier A1 coincides with the signs of the transistors M3 and M5. Accordingly, the voltage at the gate terminal of the transistors M3 and M5 varies in accordance with the input voltage of the operational amplifier A1. Further, in the operational amplifier A1, the non-inversion input terminal is supplied with the reference voltage Vref and the inversion input terminal is supplied with voltage generated through a negative feedback of the output voltage Vout, as will be described later. Thus, when the voltage generated through the negative feedback of the output voltage Vout becomes equal to the reference voltage Vref, the same current flows to the transistors M3 and MS, with the current having a current value of ([i1]/2). When the output voltage Vout is directly and negatively fed back to the inversion input terminal, and the output voltage Vout of the series regulator circuit 10 becomes equal to the reference voltage Vref, the same current flows to the transistors M3 and MS.

The transistor MS has a drain terminal connected via the transistor MG to a ground voltage GND line, which functions as a drive voltage line. In the first embodiment, the transistor MG is an n-channel MOS transistor. The transistor MG has a gate terminal and a drain terminal that are connected together.

The gate terminal of the transistor MG is connected to the gate terminal of the transistor M9. The transistor M9 is an n-channel MOS transistor like the transistor MG and has a source terminal connected to the ground voltage GND line. Thus, the transistors MG and M9 form a current mirror circuit CM1. Accordingly, current having the same value as that flowing to the transistors M5 and M6, which form the operational amplifier A1, flows to the transistor M9. In the first embodiment, the transistors M6 and M9 function as a variable current source for outputting current having a current value that is proportional to the current flowing to the first transistor or second transistor.

The transistor M9 is connected via the constant current source 21, which functions as a second constant current source, to the power supply voltage VCC line. Thus, the constant current source 21 and the current mirror circuit CM1 form a so-called current comparator. The constant current source 21 outputs current having current value i2. In the first embodiment, the current value i2 is set to a fixed value that is greater than the current value ([i1]/2) and less than the current value i1.

A connection node of the constant current source 21 and the transistor M9 is connected to an input terminal of an inverter 22. A power-up detection signal S1 for detection of voltage rising completion is output from the output terminal of the inverter 22.

The output terminal of the operational amplifier A1 is connected to the input terminal of the amplifier A2, which amplifies the output of the operational amplifier A1. Thus, the amplifier A2 is effective for a relatively balanced state in which input and output fluctuations are small. More specifically, the amplifier A2, which amplifies the output of the operational amplifier A1, reduces fluctuations that occur in the operational amplifier A1 when correcting output fluctuations. The amplifier A2 has an output terminal functioning as an output terminal of the series regulator circuit 10 and outputting the output voltage Vout. The output from the output terminal is negatively fed back to the inversion input terminal of the operational amplifier A1. In addition to a direct negative feedback of the output from the output terminal, the negative feedback may be a feedback that goes through a negative feedback element F1 as shown in FIG. 1.

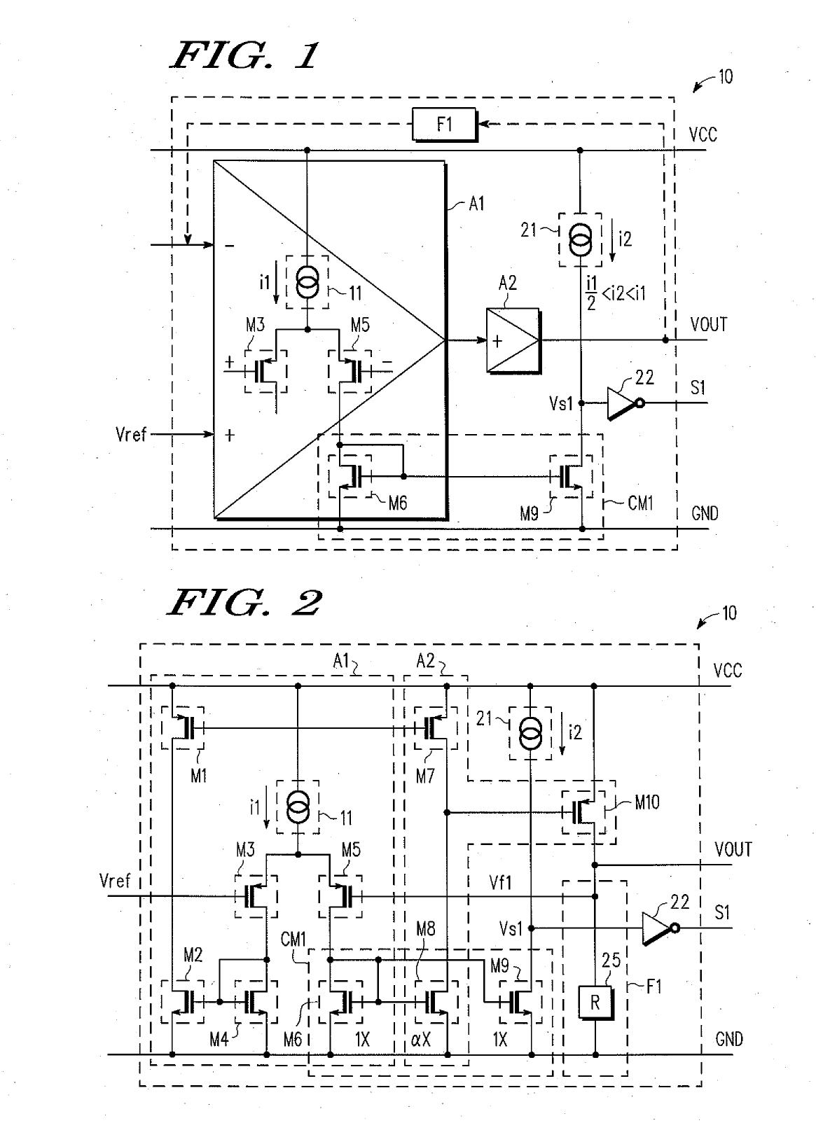

A specific example applied at an element level of the series regulator circuit 10 in the first embodiment will now be described with reference to FIG. 2. In FIG. 2, components corresponding to those of the FIG. 1 are given the same reference numerals and will not be described.

As shown in FIG. 2, the operational amplifier A1 of the present example includes the constant current source 11 and transistors Ml to M6. Further, the amplifier A2 includes transistors M7, M8, and M10. The gate terminals of the transistors M7 and M8 in the amplifier A2 are connected to the gate terminals of the transistors M1 and M6 in the operational amplifier A1. The amplifier A2 performs amplification in accordance with the difference between the voltages supplied to these gate terminals. The negative feedback element F1 is realized by the output terminal that is connected to the gate terminal of the transistor M5 in the operational amplifier A1.

Each element will now be described in detail.

Operational Amplifier A1

The gate terminal of the transistor M3 is supplied with the reference voltage Vref. The drain terminal of the transistor M3 is connected to the ground voltage GND line via the transistor M4, which is an n-channel MOS transistor. The transistor M4 has a gate terminal and a drain terminal that are connected together. The gate terminal of the transistor M4 is also connected to the gate terminal of the transistor M2.

The transistor M2, which is an n-channel MOS transistor, has a source terminal connected to the ground voltage GND line and a drain terminal connected via the transistor M1 to the power supply voltage VCC line. The transistor M1, which is a p-channel MOS transistor, has a gate terminal and a drain terminal that are connected together.

Amplifier A2

The gate terminal of the transistor M1, which forms the operational amplifier A1, is connected to the gate terminal of the transistor M7, which forms the amplifier A2. The transistor M7, which is a p-channel MOS transistor, has a source terminal connected to a power supply voltage VCC line and a drain terminal connected to the ground voltage GND line via the transistor M8, which also forms the amplifier A2.

The transistor M8, which is an n-channel MOS transistor, has a gate terminal connected to the gate terminal of the transistor M6 in the operational amplifier A1. The transistor M8 is sized to be a times greater than the transistor M6. Accordingly, when the transistor M7 does not impose a current restriction, current that is a times greater than that flowing through the transistors M5 and M6 in the operational amplifier A1 flows to the transistor M8.

In the amplifier A2, a connection node of the transistors M7 and M8 is connected to the gate terminal of the transistor M10. The transistor M10, which is a p-channel MOS transistor, has a source terminal connected to the power supply voltage VCC line and a drain terminal connected to the ground voltage GND line via a resistor 25 having resistance R. A connection node of the transistor M10 and the resistor 25 functions as an output terminal.

The output terminal of the amplifier A2 is connected to the gate terminal of the transistor MS in the operational amplifier A1.

Negative Feedback Element F1

The negative feedback element F1 of the first embodiment is a circuit that inputs the output voltage Vout and outputs the negative feedback voltage Vf1 at the gate terminal of the transistor M5. The circuit shown in FIG. 2 performs 100% negative feedback. Thus, the output voltage Vout is directly used as the negative feedback voltage Vf1. Further, the output voltage Vout may be resistor-divided to generate the negative feedback voltage Vf1. For example, in the first embodiment, when current that is 1/N of the output current Iout is fed back to the operational amplifier A1 via the resistor 25, the negative feedback voltage Vf1 at the gate terminal of the transistor MS becomes Iout/N×R.

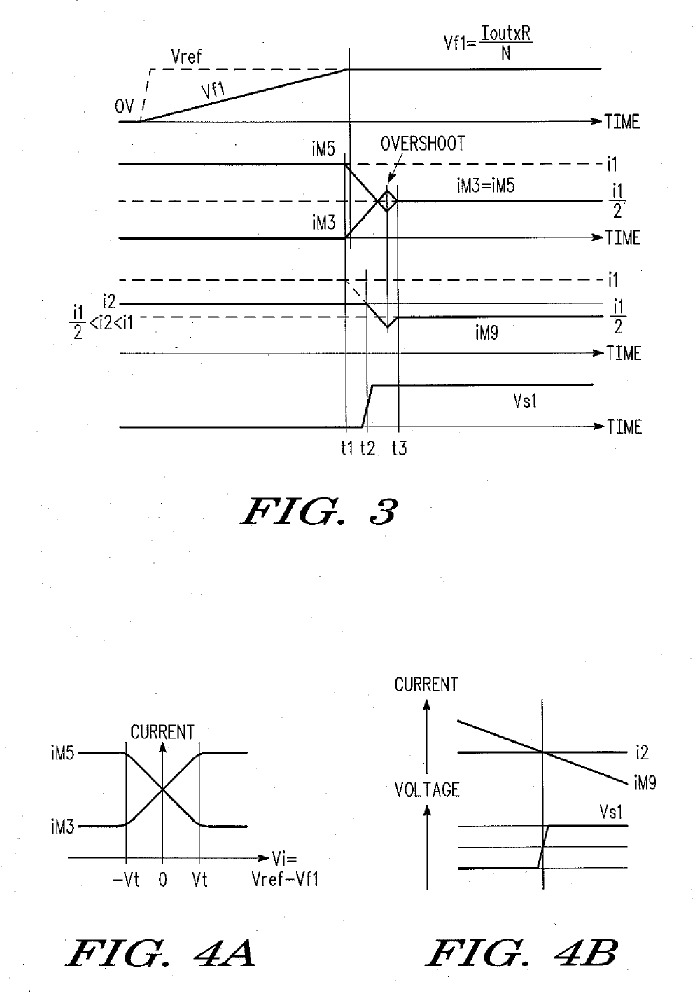

The operation of the series regulator circuit 10 will now be discussed with reference to FIGS. 3 and 4. A case in which the currents flowing to the transistors M3 and M5 overshoot and then become the same current value will be described. Referring to FIG. 3, when an external power supply is activated, the reference voltage Vref readily reaches a fixed value, and the gate terminal of the transistor M3 is supplied with the reference voltage Vref having the fixed value. In FIG. 3, the currents flowing to the transistors M3, M5, and M9 are represented by iM3, iM5, and iM9, respectively. In the same manner, in FIG. 4A, the currents flowing to the transistors M3 and M5 are represented by iM3 and iM5, respectively.

From power supply activation to time t1, the reference voltage Vref supplied to the gate terminal of the transistor M3 is sufficiently lower than the negative feedback voltage Vf1, which is supplied to the gate terminal of the transistor M5. Thus, the transistor M3 is deactivated and the transistor M5 is activated.

In this case, since the transistor M3 is deactivated, current does not flow to the transistor M4. Accordingly, the transistor M2, which forms a current mirror circuit with the transistor M4, is deactivated. Since current does not flow through the transistor M2, the transistor M1 is also deactivated. Furthermore, the transistor M7, which forms a current mirror circuit with the transistor M1, is deactivated.

Since the transistor M5 is activated, the current from the constant current source 11 entirely flows to the transistor M5 and is supplied to the transistor M6. The transistor M8 which forms a current mirror circuit with the transistor M8 of the amplifier A2, is sized to be 1/α of the transistor M8. Accordingly, the transistor M8 is activated so as to cause a flow of current that is a times greater than that of the transistor M6. The activation of the transistor M8 results in the voltage at a connection node of the transistor M7 and the transistor M8 becoming equal to the ground voltage GND via the transistor M8. Since the ground voltage GND is supplied to the gate terminal of the transistor M10, the transistor M10 is activated. As a result, the output voltage Vout increases as the power supply voltage VCC increases. Further, some of the current (Iout/N) flowing to the transistor M10 flows to the resistor 25. This increases the negative feedback voltage Vf1 as shown in FIG. 3.

Current having the same current value (here, current value i1) as the current flowing to the transistor M6 flows to the transistor M9, which forms a current mirror circuit with the transistor M6. The transistor M9 is connected to the constant current source 21 that generates a flow of current having the current value i2, which is smaller that the current value i1. Thus, referring to FIG. 3, the voltage Vs1 at a connection node of the constant current source 21 and the transistor M9 is lowered to be a low level signal voltage. Further, the inverter 22 outputs a high level signal, which is an inverted signal of the input signal, as the power-up detection signal S1.

Referring to FIG. 4A, time t1 is when the voltage difference Vi between the negative feedback voltage Vf1 supplied to the operational amplifier A1 and the reference voltage Vref is “−Vt”. The negative feedback voltage Vf1 at time t1 is lower than the reference voltage Vref. At time t1, the transistor M3 starts to become activated, and current starts to flow via the transistor M3. As shown in FIG. 3, subsequent to time t1, the current iM3 flowing to the transistor M3 increases. As the current flowing to the transistor M3 increases, the current iM5 flowing to the transistor M5 decreases. As the current iM9 flowing to the transistor M9 decreases, the current iM9 flowing to the transistor M9, which forms a current mirror circuit with the transistor M6, decreases.

Afterwards, at time t2, when the current flowing to the transistor M9 reaches the current value i2, the current flowing to the transistor M5 also reaches the current value i2.

In this case, as shown in FIG. 4B, the voltage Vs1 at a connection node of the constant current source 21 and the transistor M9 is charged up and shifts from a low level to a high level. Accordingly, the power-up detection signal S1, which is output from the inverter 22, shifts from a high level to a low level.

Subsequent to time t2, the current iM9 flowing to the transistor M9 becomes smaller than the current value of the constant current source 21. In this example, the currents flowing to the transistors M3 and M5 overshoot and then become the same value at time t3. Current iM9 having the same value as the current iM5 flowing to the transistor MS flows to the transistor M9, which forms a current mirror circuit CM1 with the transistor M6 connected to the transistor M5. Thus, the current iM9 flowing to the transistor M9 becomes constant at current value ([i1]/2) when reaching time t3.

The period subsequent to time t3 during which the currents flowing to the transistors M3, M5, and M9 become the same current value ([i1]/2) will now be discussed. Subsequent to time t3, the input and output of the series regulator circuit 10 does not change much and is thus in a balanced state. In this state, a case in which the output voltage Vout fluctuates due to noise or load current fluctuation will now be discussed. For example, if the output voltage Vout decreases, the negative feedback voltage Vf1 supplied to the gate terminal of the transistor M5 also decreases. In this case, the gate-source voltage difference of the transistor M5 increases. This facilitates the flow of current, and the current value of the current becomes greater than the current value ([i1]/2). Further, the current (output current of the operational amplifier A1) flowing to the transistor M8, which forms a current mirror circuit with the transistor M6, increases. This decreases the voltage at the gate terminal of the transistor M10. Thus, the current that flows via the transistor M10 increases and raises the output voltage Vout. This offsets the fluctuation of the output voltage Vout, and the output voltage Vout of the series regulator circuit 10 becomes constant.

Next, the feedback amount and current amount when the output voltage Vout varies subsequent to time t3 will be discussed.

The amplifier A2 amplifies the output of the operational amplifier A1. Thus, the input of the amplifier A2 need only be varied within a relatively small range to correct a change in the output voltage Vout. Further, the output current of the operational amplifier A1 is α times greater than the current flowing to the transistor M5. Thus, the current flowing to the transistors M3 and M5 need only be varied by 1/α for correction. For example, if α is equal to 10 and the amplification rate of the amplifier A2 is 10 times, when the output is varied by 10%, to correct this, the output correction of the operational amplifier A1 need only be 1%, and the current correction of the transistors M3 and M5 need only be 0.1%. Accordingly, in a balanced state, the amount of change in the current flowing to the transistors M3 and M5 is much smaller than the change in the current value i1. Further, current having the same value as that flowing to the transistor M5 flows to the transistor M9. This decreases the amount of change in the current iM9. Therefore, if the current value i2 is greater than the current value [i1]/2 by a certain level (for example, about [i1]×3/4), even if the current iM9 changes, it remains lower than the current value i2. This stabilizes the power-up detection signal S1.

The advantages of the first embodiment will now be discussed.

(1) In the first embodiment, the operational amplifier A1 includes the transistors M3 and M5, which distribute the current flowing from the constant current source 11 in accordance with the voltage difference between the reference voltage Vref and the negative feedback voltage Vf1, and the transistor M6, which is connected to the transistor M5. The transistor M6 forms the current mirror circuit CM1 with the transistor M9, which is located outside the amplifier A1. Thus, the same current as that flowing to the transistor M5 flows to the transistor M9. Further, the transistor M9 is connected to the power supply voltage VCC line via the constant current source 21. The current value i2 of the constant current source 21, which is smaller than the current value i1 of the current that flows when the transistor M5 is activated, is set to be greater than the current value ([i1]/2) of the current that flows when the output voltage Vout and the reference voltage Vref are the same.

Thus, when the output voltage Vout has substantially risen, if the current flowing to the transistor M5 varies from the current value i1 to the current value [i1]/2, the currents flowing to the transistors M5 and M9 vary accordingly. Further, if the currents flowing to the transistors M5 and M9 exceed the current value i2 of the current flowing from the constant current source 21, the voltage Vs1 at the connection node of the transistor M9 and the constant current source 21 varies. This varies the power-up detection signal S1. In this manner, the current of the transistor M5, which varies when the output voltage Vout and the reference voltage Vref are the same, is used to output the power-up detection signal S1. Thus, the rising of the voltage can be detected even when the output voltage Vout fluctuates or when an offset occurs.

(2) In the first embodiment, the series regulator circuit 10 uses the operational amplifier A1, which varies the distributed current amount, in accordance with the voltage difference Vi between the reference voltage Vref and the negative feedback voltage Vf1. The operational amplifier A1 includes the transistor M6, which is connected to the transistor M5. The transistor M6 forms the current mirror circuit CM1 with the transistor M9. Accordingly, the power-up detection signal S1 is generated using the change in the current flowing to the transistors M3 and M5, which form the differential pair that is originally incorporated in the operational amplifier A1. Thus, by using only the transistor M9 and the constant current source 21 in addition to the operational amplifier A1, the rising of the voltage can be detected. This reduces the number of components used in addition to the operational amplifier A1.

(3) In the first embodiment, the output terminal of the operational amplifier A1 in the series regulator circuit 10 is connected to the amplifier A2, which amplifies the output of the operational amplifier A1. The output terminal of the amplifier A2 functions as the output terminal of the series regulator circuit 10 and outputs the output voltage Vout. Further, the inversion input terminal of the operational amplifier A1 is supplied with the voltage resulting from the negative feedback of the output voltage Vout. Thus, the amplifier A2 amplifies the output voltage Vout from the output of the operational amplifier A1. However, the voltage of the power-up detection signal S1 is not amplified. Accordingly, this suppresses the fluctuation amounts of the currents iM3 and iM5 that flow to the transistors M3 and M5 in the operational amplifier A1 when the output voltage Vout fluctuates. Thus, fluctuation of the current iM9 that flows to the transistor M9 is suppressed. As a result, after the rising of the voltage, fluctuations of the power-up detection signal S1 corresponding to fluctuations of the output voltage are suppressed, and the power-up detection signal S1 is stabilized.

(4) In the present example, the transistor M8 of the operational amplifier A1 is sized to be α times greater than the transistor M6. Thus, the output current of the operational amplifier A1 in the first embodiment becomes a times greater than the current flowing to the transistor MS. Thus, when correcting fluctuations in the output voltage Vout of the series regulator circuit 10, the adjustment amount of the current flowing to the transistor M5 is reduced in comparison with the output of the operational amplifier A1. Accordingly, fluctuations of the current iM9 flowing to the transistor M9 are further suppressed, and the power-up detection signal S1 is further stabilized.

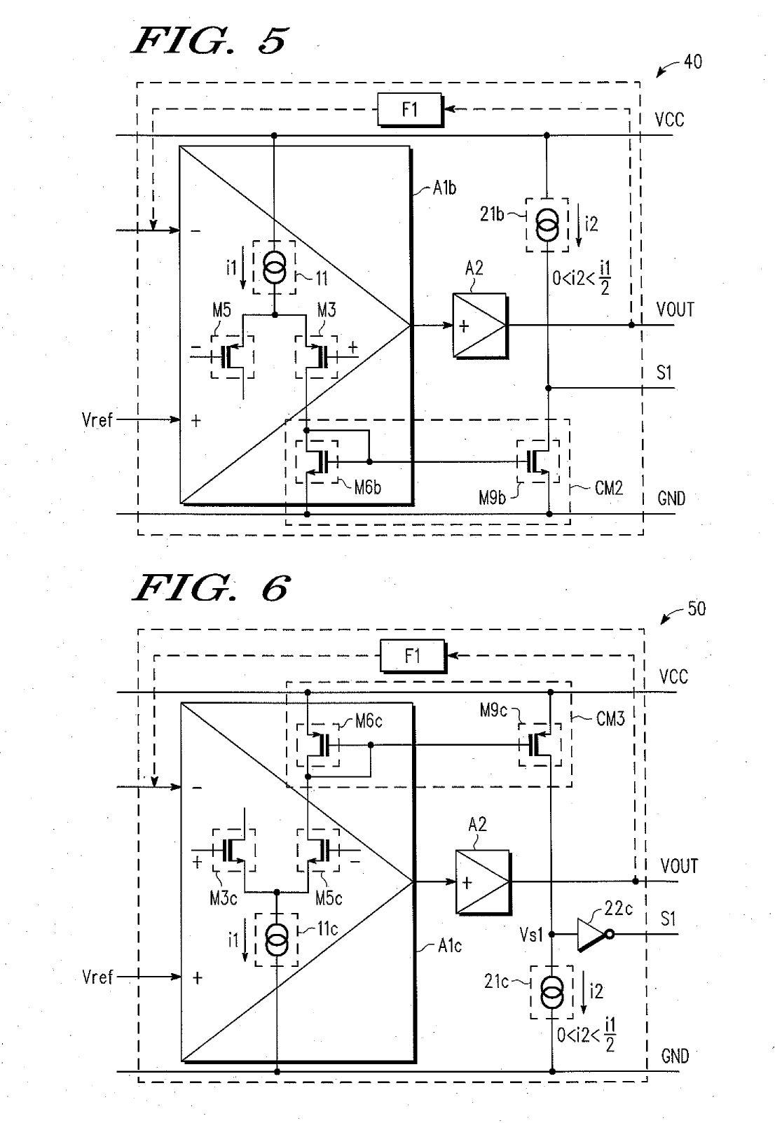

A second embodiment of the present invention will now be discussed with reference to FIG. 5. To avoid redundancy, like or same reference numerals are given to those components that are the same as the corresponding components of the first embodiment. Such components will not be described in detail. In the second embodiment, “b” is added to reference numerals given to components having the same function as the corresponding components of the first embodiment.

In the second embodiment, a series regulator circuit 40 uses the current flowing to a transistor M3 of an operational amplifier A1b to generate the power-up detection signal. More specifically, the drain terminal of the transistor M3 is connected to the ground voltage GND line via a transistor M6b. In the second embodiment, the transistor M6b is an n-channel MOS transistor. The transistor M6b has a gate terminal and a drain terminal that are connected together. Further, the gate terminal of the transistor M6b is connected to the gate terminal of a transistor M9b. The transistor M9b is an n-channel MOS transistor like the transistor M6b and includes a source terminal connected to the ground voltage GND line. Accordingly, the transistors M6b and M9b form a current mirror circuit CM2. Further, current having the same value as the current flowing through the transistor M3 of the operational amplifier A1b flows to the transistor M9b.

Additionally, the transistor M9b is connected to the power supply voltage VCC line via a constant current source 21b. Thus, the constant current source 21b and the current mirror circuit CM2 form a so-called current comparator. In the second embodiment, the current value i2 of the constant current source 21b is set to be a fixed value that is greater than “0” and less than current value ([i1]/2).

Further, in the second embodiment, the voltage at a connection node of the constant current source 21b and the transistor M9b is used as the power-up detection signal S1.

In the second embodiment, the operational amplifier A1b is connected to the input terminal of the amplifier A2. The output terminal of the amplifier A2 functions as the output terminal of the series regulator circuit 40.

In the same manner as in the first embodiment, in the second embodiment, when the external power supply is activated and the reference voltage Vref readily reaches a fixed value, the transistor M3 is deactivated and the transistor M5 is activated in the operational amplifier A1b. Thus, current does not flow to the transistor M3, and current having current value i1 flows to the transistor M5. Since current does not flow to the transistor M3, the transistor M6b is deactivated, and the transistor M9b, which forms the current mirror circuit CM2 with the transistor M6b, is also deactivated. Thus, the current that flows from the constant current source 21b charges up the voltage at the connection node of the constant current source 21b and the transistor M9b. This outputs the power up detection signal S1 as a high level signal.

Afterwards, the negative feedback voltage Vf1 increases. When the voltage difference Vi in the operational amplifier A1b between the negative feedback voltage Vf1 and the reference voltage Vref becomes equal to voltage “−Vt”, the transistor M3 is activated so that current starts to flow. This starts activation of the transistors M6b and M9b so that current starts to flow to the transistors M6b and M9b. As the output voltage Vout increases, the current flowing to the transistor M5 decreases and the current flowing to the transistors M3, M6b, and M9b increases.

When the current flowing to the transistor M9b becomes equal to the current value i2 of the constant current source 21b, the voltage at the connection node of the constant current source 21b and the transistor M9b is decreased. Accordingly, the output power-up detection signal S1 shifts from a high level to a low level. Subsequently, the power-up detection signal S1 is output at a low level. In this state, the output voltage Vout of the series regulator circuit 40 becomes the same value as the reference voltage Vref in the same manner as the first embodiment.

In addition to advantage (3) of the first embodiment, the second embodiment has the advantages described below.

(5) In the second embodiment, the operational amplifier A1b includes the transistor M6b, which is connected to the transistor M3. The transistor M6b forms a current mirror circuit CM2 with the transistor M9b, which is located outside the operational amplifier A1b. Thus, the same current as the current flowing to the transistor M3 flows to the transistor M9b. Further, the transistor M9b is connected to the power supply voltage VCC line via the constant current source 21b and forms a current comparator. The current value i2 of the constant current source 21b is greater than the current value “0” of the current that flows when the transistor M3 is activated and less than the current value ([i1]/2) of the current that flows when the output voltage Vout is equal to the reference voltage Vref.

Therefore, if the current flowing to the transistor M3 changes from current value “0” to current value [i1]/2 when the output voltage Vout has substantially risen, the currents flowing to the transistors M3 and M9b change accordingly. When the current flowing to the transistor M9b exceeds the current value i2 of the current flowing from the constant current source 21b, the power-up detection signal S1 having the voltage at the connection node of the transistor M9b and the constant current source 21b changes. In this manner, the power-up detection signal S1 is output using the change in the current flowing to the transistor M3 when the output voltage Vout becomes substantially equal to is the reference voltage Vref. Thus, the rising of the voltage can be detected even when the output voltage Vout fluctuates or includes an offset.

(6) In the second embodiment, the series regulator circuit 40 uses the operational amplifier A1b including the transistors M3 and M5. The amount of current distributed to each of the transistors M3 and M5 from the constant current source 11 changes in accordance with the voltage difference Vi between the reference voltage Vref and the negative feedback voltage Vf1. The operational amplifier A1b further includes the transistor M6b, which is connected to the transistor M3. The transistor M6b forms the current mirror circuit CM2 with the transistor M9b. The transistor M9b forms a current comparator with the constant current source 21b. Accordingly, the power-up detection signal S1 is generated in accordance with changes in the amount of current flowing to the transistor M3, which is originally incorporated in the operational amplifier A1b.

(7) In the second embodiment, the current value i2 of the current flowing from the constant current source 21b is set at a value that is smaller than the current value ([i1]/2). Thus, in comparison with the constant current source 21 of the first embodiment, the current flowing from the constant current source 21b may be reduced. Accordingly, the current consumption may be decreased.

A third embodiment of the present invention will now be discussed with reference to FIG. 6. In the third embodiment, “c” is added to reference numerals given to components having the same function as the corresponding components of the first embodiment.

In the third embodiment, a series regulator circuit 50 is configured so that the connection to the power supply voltage VCC line and the ground voltage GND line is reversed from that of the first embodiment.

More specifically, an operational amplifier A1c includes transistors M3c, M5c, and M6c and a constant current source 11c. In the third embodiment, the transistors M3c and M5c are n-channel MOS transistors. The transistors M3c and M5c respectively have gate terminals directly or indirectly supplied with voltages that vary in the same manner as the voltages input to the operational amplifier A1. The operational amplifier A1c has a non-inversion input terminal supplied with the reference voltage Vref and an inversion input terminal supplied with the voltage resulting from the negative feedback of the output voltage Vout. Further, the transistors M3c and M5c have source terminals connected to the ground voltage GND line via the constant. current source 11c. The constant current source 11c generates a flow of current having current value i1.

The transistor M6c, which is a p-channel MOS transistor, has a source terminal connected to the power supply voltage VCC line.

The drain terminal and source terminal of the transistor M6c are connected to the gate terminal of a transistor M9c. The transistor M9c, which is a p-channel MOS transistor, includes a source terminal connected to the power supply voltage VCC line. Thus, the transistors M6c and M9c form a current mirror circuit CM3. The current flowing to the transistor M9c has the same value as the currents flowing to the transistors M5c and M6c of the operational amplifier A1c.

The transistor M9c is connected to the ground voltage GND line via a constant current source 21c. Thus, the constant current source 21c and the current mirror circuit CM3 form a so-called comparator. The constant current source 21c outputs current having a current value i2. In the third example, the current value i2 is set to a fixed value that is greater than current value “0” and less than current value ([i1]/2).

A connection node of the constant current source 21c and the transistor M9c is connected to the input terminal of the inverter 22c. The power-up detection signal S1 is output from the output terminal of the inverter 22c.

In the third embodiment, the operational amplifier A1c is connected to the input terminal of the amplifier A2. The output terminal of the amplifier A2 functions as the output terminal of the series regulator circuit 50.

In the third embodiment, when an external power supply is activated and the reference voltage Vref readily reaches a fixed value, the transistor M3c is activated and the transistor M5c is deactivated in the operational amplifier A1c. Thus, current having current value i1 flows to the transistor M3c, and current does not flow to the transistor M5c. Since current does not flow to the transistor M5c, the transistor M6c is deactivated. Further, the transistor M9c forming the current mirror circuit CM3 with the transistor M6c is deactivated. Thus, current does not flow from the power supply voltage VCC line via the transistor M9c, and the voltage Vs1 at the connection node of the constant current source 21c and the transistor M9c is decreased. Accordingly, the inverter 22c outputs a power-up detection signal S1 having a high level.

Afterwards, as the negative feedback voltage Vf1 increases and the output voltage Vout becomes close to the reference voltage Vref, current starts to flow as the transistor M5c is activated. As a result, current also flows to the transistors M6c and M9c. Subsequently, the current flowing to the transistor M3c decreases, and the current flowing to the transistors M5c, M6c, and M9c increases. When the current flowing to the transistor M9c becomes equal to and then exceeds the current value i2 of the constant current source 21c, the voltage Vs1 at the connection node of the constant current source 21c and the transistor M9c is charged up and shifted from a low level signal voltage to a high level signal voltage. Accordingly, the power-up detection signal S1 subsequently has a low level. In this state, the output voltage Vout of the series regulator circuit 50 has the same value as the reference voltage Vref in the same manner as the first embodiment.

The third embodiment has advantages (3) and (5) to (7) of the first and second embodiments.

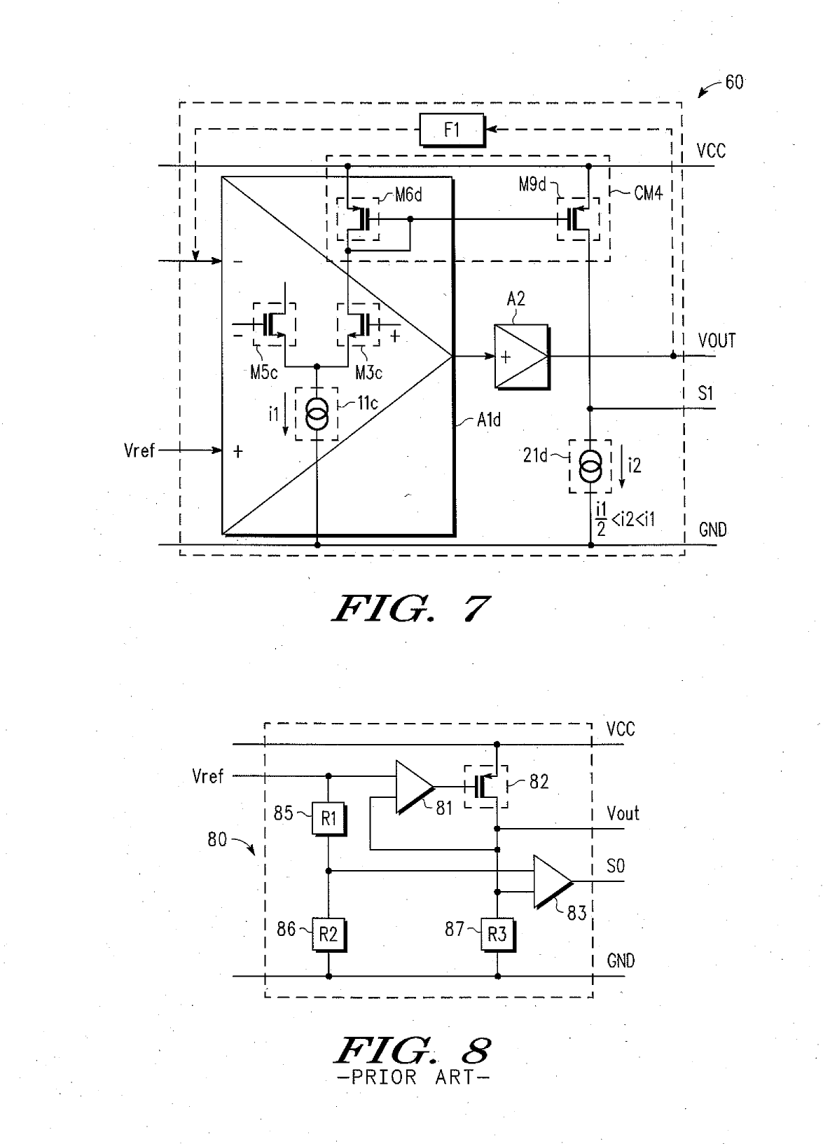

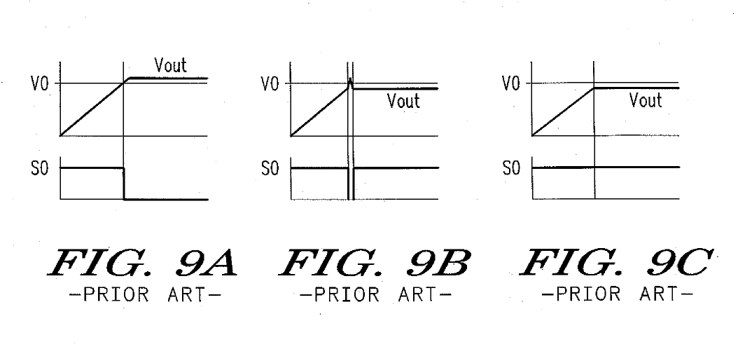

A fourth embodiment of the present invention will now be discussed with reference to FIG. 7. To avoid redundancy, like or same reference numerals are given to those components that are the same as the corresponding components of the first and third embodiments. Such components will not be described in detail. In the fourth embodiment, “d” is added to reference numerals given to components having the same function as the corresponding components of the first embodiment.

In the fourth embodiment, a series regulator circuit 60 uses the current that flows to a transistor M3c to generate a power-up detection signal. More specifically, the transistor M3c has a drain terminal connected to the power supply voltage VCC line via a transistor M6d. In the fourth embodiment, the transistor M6d is a p-channel MOS transistor. The transistor M6d has a gate terminal and a drain terminal that are connected together. Further, the gate terminal of the transistor M6d is connected to the gate terminal of a transistor M9d. The transistor M9d, which is a p-channel MOS transistor like the transistor M6d, has a source terminal connected to the power supply voltage VCC line. Accordingly, the transistors M6d and M9d form a current mirror circuit CM4, and the current flowing to the transistor M9d has the same value as the current flowing to the transistor M3c, which forms an operational amplifier A1d.

The transistor M9d is connected to the ground voltage GND line via a constant current source 21d. Thus, the constant current source 21d and the current mirror circuit CM4 form a so-called current comparator. In the fourth embodiment, the current flowing from the constant current source 21d has a current value i2 set to a fixed value that is greater than the current value ([i1]/2) and less than current value i1.

In the fourth embodiment, the voltage at a connection node of the constant current source 21d and the transistor M9d is used as a power-up detection signal S1.

In the fourth embodiment, the operational amplifier A1d is connected to the input terminal of an amplifier A2. The output terminal of the amplifier A2 functions as the output terminal of the series regulator circuit 60.

In the fourth embodiment, when an external power supply is activated and the reference voltage Vref readily reaches a fixed value, the transistor M3c is activated and the transistor M5c is deactivated in the operational amplifier A1d. Thus, current having current value i1 flows to the transistor M3c, and current does not flow to the transistor M5c. As a result, the transistor M6d connected to the transistor M3c is activated, and the transistor M9d forming the current mirror circuit CM4 with the transistor M6d is activated. This generates a flow of current having the same current value i1 as the current flowing to the transistor M3c. As a result, the voltage at the connection node of the transistor M9d and the constant current source 21d is charged up so that the power-up detection signal S1 is output at a high level.

Afterwards, as the negative feedback voltage Vf1 increases and the output voltage Vout becomes close to the reference voltage Vref, current starts to flow as the transistor M5c is activated. As a result, the current flowing to the transistors M3c, M6d, and M9d decreases. As the output voltage Vout increases, the current flowing to the transistors M3c, M6d, and M9d decreases, and the current flowing to the transistor M5c increases.

When the current flowing to the transistor M9d becomes less than the current value i2 of the constant current source 21c, the voltage at the connection node of the constant current source 21c and the transistor M9d is decreased. Subsequently, the power-up detection signal S1 is output as a low level signal. In this state, the output voltage Vout of the series regulator circuit 60 has the same value as the reference voltage Vref in the same manner as the first embodiment.

The fourth embodiment has advantages (1) to (3) of the first embodiment.

It should be apparent to those skilled in the art that the present invention may be embodied in many other specific forms without departing from the spirit or scope of the invention. Particularly, it should be understood that the present invention may be embodied in the following forms.

The first and third embodiments respectively include the inverters 22 and 22c that are supplied with the voltages at the connection nodes of the constant current sources 21 and 21c and the transistors M9 and M9c. Further, the first and third embodiments use the outputs of the inverters 22 and 22c as the power-up detection signal S1. The second and fourth embodiments respectively use the voltages at the connection nodes of the constant current sources 21b and 21d and the transistors M9b and M9d as the power-up detection signal S1. However, the present invention is not limited in such a manner, and the inverters 22 and 22c may be eliminated in the first and third embodiments. Further, in the second and fourth embodiments, the output of an inverter, which is supplied with the voltages at the connection nodes of the constant current sources 21b and 21d and the transistors M9b and M9d, may be used as a power-up detection signal.

In the above embodiments, the same current flows in the transistors M6, M6b, M6c, and M6d of the operational amplifiers A1, A1b, A1c, and A1d and the transistors M9, M9b, M9c, and M9d of the current mirror circuits CM1, CM2, CM3, and CM4. However, the present invention is not limited in such a manner. For example, the transistors M9, M9b, M9c, and M9d may be sized to be 1/n the size of the transistors M6, M6b, M6c, and M6d so as to reduce the currents flowing to the transistors M9, M9b, M9c, and M9d. In such cases, the constant current sources 21, 21b, 21c, and 21d may be set so that the value of the current value flowing to the transistors M9, M9b, M9c, and M9d changes when the negative feedback voltage Vf1 becomes close to the reference voltage Vref. This decreases the current flowing to the constant current sources and lowers current consumption.

In the above embodiments, the output terminal of the operational amplifier A1 is connected to the input terminal of the amplifier A2, and the amplifier A2 amplifies the output of the operational amplifier A1. However, the present invention is not limited in such a manner. If the output voltage Vout subtly fluctuates and the current flowing to the transistor M9 does not easily exceed the current value i2 after the voltage rises, the amplifier A2 that amplifies the output of the operational amplifier A1 may be eliminated.

The present examples and embodiments are to be considered as illustrative and not restrictive, and the invention is not to be limited to the details given herein, but may be modified within the scope and equivalence of the appended claims.

1. A series regulator including an operational amplifier incorporating a differential means formed by a first transistor and a second transistor, which distribute current of a first constant current source, wherein the series regulator circuit outputs an output voltage in accordance with an output of the operational amplifier, the series regulator circuit comprising:
a variable current source for outputting current having a current value that is proportional to current flowing to the first transistor or the second transistor; and
a second constant current source for forming the variable current source and a current comparator;
wherein the first transistor has a control terminal supplied with a reference voltage, the second transistor has a control terminal supplied with a negative feedback voltage that is based on the output voltage, and current that is in accordance with the voltage difference between the negative feedback voltage and the reference voltage flows to the first transistor and second transistor;
the second constant current source generates current having a predetermined current value, which is in the range of the current output from the variable current source, from when entering an activated state in which the reference voltage is supplied to when the negative feedback voltage and the reference voltage become equal to each other; and
voltage at a connection node of the variable current source and the second constant current source is used to output a power-up detection signal.

2. The series regulator circuit according to claim 1, wherein the variable current source includes:
a third transistor connected to the first transistor or the second transistor and incorporated in the operational amplifier; and
a fourth transistor forming a current mirror circuit with the third transistor and connected to the second constant current source.

3. The series regulator circuit according to claim 1, wherein:
the variable current source generates current having a current value that is proportional to the first or second transistor that stops the flow of current in the activated state; and
the predetermined current value of the second constant current source is a value that is greater than zero and less than one half the current generated by the first constant current source.

4. The series regulator circuit according to claim 1, wherein:
the operational amplifier has an output terminal connected to an amplifier for amplifying an output of the operational amplifier; and
voltage at the output terminal of the amplifier is the output voltage.

5. The series regulator circuit according to of claim 1, wherein the first and second constant current sources are connected to a power supply voltage line, and the variable current source is connected to a drive voltage line.

6. The series regulator circuit according to claim 1, wherein the first and second constant current sources are connected to a drive voltage line, and the variable current source is connected to a power supply voltage line.
